(19) United States
(12) Patent Application Publication
(10) Pub. No.: US 2002/0044695 A1
(43) Pub. Date: Apr. 18, 2002

(54) Method for wavelet-based compression of video images

(76) Inventor: Alistair K. Bostrom, Keaau, HI (US)

Correspondence Address: BAKER, DONELSON, BEARMAN & CALDWELL, Suite 900, Five Concourse Parkway, Atlanta, GA, 30328, US

(21) Appl. No.: 09/849,751

(22) Filed: May 4, 2001

Related U.S. Application Data
(60) Provisional application No. 60/202,130, filed on May 5, 2000.

(51) Int. Cl. G06K 9/46; G06K 9/36

(52) U.S. Cl. 382/240; 382/245; 382/246

(57) ABSTRACT

A method for lossy compression of digitized images involves wavelet transformation, extension of image dimension factors with allocation to memory, and discrete wavelet transformation.

### REFERENCE TO RELATED APPLICATION

This application is based on Provisional Application serial 60/202,130 filed May 5, 2000.

### BACKGROUND OF THE INVENTION

For purposes of description the present invention and its method will be referenced herein as “ThinWave”.

ThinWave is a method for performing lossy compression of an-bit color or m-bit grayscale bitmaps of arbitrary size. Typical values of “n” and “m” are 24 bit and 8 bit respectively.

Images compressed into the ThinWave format typically require from one to ten percent of the storage space used for the original bitmap. The term lossy means that once an image is compressed in the ThinWave format, the exact original is not recoverable from the ThinWave compression. While ThinWave format does not permit recovery of the exact original, the human eye perceives the decompressed image as being very close to the original. This method, described herein, is specifically designed for use with low-end, embedded processors, whose execution speed as well as data and program memory may be severely limited. The output quality has been found to be subjectively and objectively comparable with more complex techniques such as JPEG 2000.

In most lossy compression schemes, information is lost in the quantization step where image data is mapped by a quantization function to bit sequences that are shorter than the sequences containing the original data. In lossy compression a goal is to realize a quantization that achieves optimal rate-distortion, i.e., the least distortion of the data, for a given number of bits output. To achieve optimal rate-distortion, many schemes use more or less elaborate mechanisms, such as repeated steps of quantization followed by comparison and adjustment of the quantizer parameters until minimum distortion according to some measure is met. To avoid the inevitable computational cost associated with optimization on a per-image bases, ThinWave uses a carefully chosen, fixed quantizer, which achieves nearly optimal quantization with minimized computation cost and small program size.

Another issue arising in wavelet-based compression is the handling of image boundaries. Image boundaries pose a difficulty because the first and last pixels in each scan line are often widely disparate, resulting in many coefficients being needed to represent that jump in the wavelet transform. This in turn degrades the final compression rate. Various schemes have been identified by the present inventor to alleviate this problem, including zero-padding, symmetric reflection of the end points, and the use of special wavelets invoked near the boundaries, the last also known as a shift-variant transform. The last two methods suffer from the fact that they both involve additional exception handling in the code, leading to increased program code size and slower execution. Zero padding is weak in that there will likely still be a sizable jump from the last valid pixel to whatever value is chosen for the zero pad. Therefore, in the interest of maintaining simplicity of code, minimized execution time while minimizing boundary artifacts, a preferred embodiment of ThinWave uses a modification of zero-padding wherein the pad is generated by a simple interpolation consisting of a line fitted to the first and last pixels in each scan. The padding can be explicitly written to a pad of additional memory around the image, or it can easily be generated in a ‘virtual’ sense, with simple code in the wavelet transformation.

Huffman coding is used by many compression schemes. One of the drawbacks of Huffman coding, however, is that a Huffman coded data file needs a codebook to decode the variable length bit sequences generated by the Huffman coder. Thus, the decoder must somehow receive or already contain a copy of this codebook. Ideally, for best compression of the data itself, the coder should generate a new codebook for each data set and transmit this codebook to the decoder. This of course degrades the ultimate compression rate because of the codebook storage overhead. Using a fixed codebook, understood, a priori, to be used by the coder and decoder is less than satisfactory, since the optimum compression rate is achieved with a codebook built for each data set. A number of schemes exist in which the codebook is semi-fixed, where the coder and decoder each contain several codebooks. The coder determines which codebook will be best, codes the data by that book, and sends a token along with the coded data to the receiver telling it which codebook to use. This method, however, suffers from the defect that for large data sets, a less than optimal codebook and the subsequent degradation in compression rate, can very easily negate any advantage gained by not explicitly transmitting a codebook along with the data. Additional program code and computation is also needed by the coder to determine the best codebook to use.

### SUMMARY OF THE INVENTION

The preferred embodiment of ThinWave generates codebooks by a computationally simple scheme, where the codebooks are stored as an implicitly ordered sequence of small (typically with a value <16) integers which describe the length of each of the variable length words in the codebook. Since these integers are small, they can stored by words whose length is log₂ (Longest Code Word). With this method, optimal codebooks can be generated for each data set and be stored in about 25% of the space needed for the original codebook. This allows the use of multiple coders with smaller data sets, allowing better compression of the statistically different bands within the wavelet transformation, with minimized codebook overhead, program size and execution time.

### DETAILED DESCRIPTION

There are four main steps performed by the ThinWave method to compress or “encode” an image. In sequence, these are wavelet transformation, quantization, run length encoding and entropy coding. Like encoding, there are four main steps performed by the ThinWave method to decode a compressed image. In order of the operation performed, these are entropy decoding, run length decoding, inverse quantization and inverse wavelet transformation.

The described example of ThinWave is designed to compress 24-bit RGB color bitmaps that use standard RGB coding, wherein each of the primary colors, red, green and blue, is stored as an 8-bit value. These are combined to produce a color image on the monitor, with each pixel being represented by a triplet of 8-bit RGB values.

It is well known that while the human eye is very sensitive to changes in brightness, it is rather insensitive to variations in color intensity and hue. Thus, before encoding a color picture, ThinWave performs a linear transformation on the RGB triplets, converting them to floating point YIQ triplets, where Y (luminance) is the brightness of the color, I (hue) is the actual color and Q (saturation) is the intensity of the color.

Because the human eye is far less sensitive to discrepancies in the I and Q channels, these can be compressed much more, with no noticeable degradation. For the same reason, NTSC color television signals are transmitted with bandwidths of 4 MHz, 1.5 MHz and 0.6 MHz for the YIQ channels respectively. When ThinWave decompresses a picture, it is decompressed to YIQ, then the inverse of the matrix used to map RGB to YIQ is applied to the YIQ triples and the RBG picture is recovered for display on an RGB device.

Since each pixel of a color image is stored by three values, compression/decompression is actually run three times for a color picture, once for each of the three 8-bit planes that store the Y, I and Q channels. Thus for compressing a color picture, the sequence used by this example of the ThinWave method is,

Transform RGB triplets to YIQ triplets

Compress Y channel and store

Compress I channel and store

Compress Q channel and store

The decoding sequence is,

Decompress Y channel

Decompress I channel

Decompress Q channel

Transform YIQ triplets to RGB triplets

The Y channel is what is being viewed when looking at grayscale pictures. Because the three passes by the compressor through the color channels are identical to one another, only differing by which channel they are operating on, it is hereinafter assumed that an 8-bit grayscale image is being compressed/decompressed.

The following provides details of each step of the ThinWave compression method.

The first step of the ThinWave compression is the wavelet transformation. The wavelet transformation decomposes the image onto an orthogonal set of basis functions called wavelets. Scaled and translated copies of a single wavelet (also known as the mother wavelet) form this set of basis functions. ThinWave uses any of several members of the Daubechies wavelets□, named after Ingrid Daubechies who discovered this type of wavelet. Because it only uses scaled and translated copies of one wavelet, ThinWave uses what is known as a shift-invariant wavelet transform.

The described example of ThinWave uses a recursive implementation of Mallat's Pyramidal scheme □ wherein a pair of decimating low and high pass (also known as quadrature mirror □) filters are convolved with the data, resulting in two channels of output, each of which is half the size of the original data set. The low pass output is a smoothed, half size replica of the original data. This filter's output is

$${a}_{i} = \frac{1}{2} {\sum }_{j = 0}^{N - 1} {c}_{2 i - j + 1} {f}_{j} , i = 0 , 1 , … , \frac{N}{2} - 1$$

with N being the input block size, c the filter coefficients, f the input function and a is the output function. This filter is also known as the scaling function φ, since it is this function that scales the data down for the next pass. The high pass output contains the high frequency detail contained in the data. The high pass filter's output is

$${b}_{i} = \frac{1}{2} {\sum }_{j = 0}^{N - 1} {( - 1 )}^{j} {c}_{j - 2 i} {f}_{j} , i = 0 , 1 , … , \frac{N}{2} - 1.$$

This filter is also known as the wavelet function, Ψ, since the wavelet coefficients are generated by it. Its output also decimates the data by a half. The filter pair is run again on the low pass output, resulting now in two, quarter size channels of output. In general, this recursion can be continued until the low pass output is but one number. This number and the collection of high pass outputs that were produced constitute the wavelet transform of the data. It is evident that the size of the data set must be restricted to integral powers of two and for a set whose size is 2″, n recursions are needed for the transform. In practice however, it is not necessary to recur this far. Four to six recurrences are sufficient for compression purposes and ThinWave follows this, unless overridden by the user. For consistency of terminology, the number of recurrences used to totally or partially transform a data set is referenced herein as the transform depth.

Since images are two-dimensional, some means is needed to apply the above one-dimensional formulas to them. ThinWave uses what is known as a nonstandard decomposition[] to achieve this. This is accomplished by defining a 2-dimensional scaling function,

φφ(x,y)≈φ(x)φ(y)

and three 2-dimensional wavelet functions defined by,

φΨ(x,y)≈φ(x)Ψ(y)

Ψφ(x,y)≈Ψ(x)φ(y)

ΨΨ(x,y)≈Ψ(x)Ψ(y)

In practice this is done as follows. First the rows of the image are filtered by φ(x) and Ψ(x) then we apply the filters φ(y) and Ψ(y) to the columns of the resulting output. This results in four quadrants corresponding to the four, 2-dimensional filters. The process is repeated on the quadrant produced by the low pass in both directions.

The nonstandard decomposition has the advantage of being slightly more efficient than the standard decomposition. In a standard decomposition, all row operations are performed first, then column operations are applied the result. For a m×m image, standard decomposition requires 4(m²−m) assignment operations whereas the standard decomposition only needs 8/3 (m²−1) assignment operations[].

ThinWave uses recursion to build a quad-tree structure, with nodes that correspond to the quadrants at each level of recursion. Each recursion level can be thought of as a resolution band (or simply a band) while the quadrants in each band can be thought of as subbands. Only the nodes containing the φφ output have children. ThinWave determines the depth of the transform and hence the quad-tree, automatically.

As previously noted, because each pass of the filters decimates the data by half, the pyramidal wavelet transform is restricted to operating on data sets whose size is an integral power of two. However, in practice it is not necessary to perform a complete transform, so this condition can be relaxed somewhat. If, for example, only four levels of recurrence are to be performed, then the size of the data set need only contain four factors of two=13 i.e. be evenly divisible by sixteen. This still doesn't allow arbitrary data set sizes, so ThinWave does a further analysis. The procedure, in one dimension, is as follows.

Let N=data set size

Let k=number of factors of 2 in N

Let L=desired transform depth

```
while (k<L)
{
  increment N
  k = number of factors of 2 in the new N
}
```

The new value of N will now be sufficiently rich in powers of two that the desired transform depth can be carried out, using N as the new data block size. The data is padded with a linear interpolation between the last valid data element and the first. This extra padding has very little impact on the final compressed size, as it does not show up in the wavelet transform until the bottom of the tree, where the lowest frequency (i.e. coarsest) image details are. These coarse details are represented by few coefficients. Also the higher order derivatives at the junctions of the valid data and interpolated pad are generally smaller than they would be if one simply performed a wrap around with the sudden and often large jump from the last data element and the first. This actually causes the final compressed size to usually be smaller than it would be without the padding. ThinWave carries this out for both dimensions of the image, thus allowing arbitrary image sizes.

The wavelet transform is stored as an array of floating point coefficients. At this point, no image compression has taken place. The inverse wavelet transform could be applied and the exact original recovered, at least to the precision that the floating-point type used is capable of.

Quantization (sometimes knows as binning) is the process of converting these floating point coefficients, into a smaller set of integer coefficients or bins. After quantization, the exact original cannot be recovered, as information has been discarded, hence this is the “lossy” part of the algorithm.

A K-level scalar quantization function, q, is a nonlinear, noninvertible mapping of real numbers to a set of K numbers {r₁, . . . , rₖ} according to,

q(x)=rₖif dₖ₋₁<x≦dₖ,k=1, . . . ,K

where dₒ<r₁<d₁<r₂<. . . <rₖ<dₖ.

The dₖ are called decision levels and the rₖ representation levels. The set of representation levels {r₁,r₂, . . . rₖ}, is called the quantizer's alphabet.

ThinWave's quantizer outputs a fixed code length of 32 bits. At each scale (band) in the wavelet transform, the probability distribution of the coefficients is different. For example, the wavelet coefficients produced by the first pass are likely to be quite sparse. In other words, most of the coefficients are close to zero, while at the coarser levels of resolution, the proportion of near zero coefficients will be less.

Suppose L=depth of transform

Define Q={q₁, q₂, . . . q_{L}} where each q₁ is a quantization function, as described above.

For each q₁ define its decision and hence, representation levels by dₗₖ=α₁Ck where α₁ is the step size coefficient for q₁ and C is the compression rate parameter input by the user. C is typically a value between 10 and 60.

To minimize the distortion whilst using the smallest alphabet, a different quantization map, q₁ is used at each level of resolution. In the interest of reducing computational complexity, a fixed set of a are used. These were arrived at by subjective and quantitative measurement of a large set of diverse test images. The core set of images used were the publicly available test suite from the University of Waterloo, designed specifically to expose the relative weakness employed the often used PSNR or Peak signal-to-Noise ratio, which is a measure of the difference between the image reconstructed from the compressed data dn the original image. This is defined as

$$PSNR = 20 {log}_{10} , ( \frac{b}{r m s} ) ,$$

where b is the largest possible value of the signal (255) and rms is the rms difference between the two images. PSNR is in decibels (dB) and an increase of 20 dB in the PSNR represents a ten-fold decrease in the rms difference between two images. It is well known though, that PSNR is not a measure of perceived quality, i.e., subjective quality [Fisher, p311]. As far as the inventors of this method are aware of, no objective measure of distortion has been found, so far, that corresponds perfectly to what the human eye perceives.

The Waterloo suite was run many times with the goal being maximization of the averaged PSNR for the entire suite. Each time it was run, the result was noted and the α were adjusted slightly to achieve a better average PSNR. This amounts to a manually accomplished annealing process. Because PSNR does not correspond exactly to perceived quality, the coefficients wee subsequently further modified by visual examination of the waterloo suite and many other images.

This affects a slightly sub-optimal alphabet-constrained-quantizer that could also be called a sub-optimal Lloyd-Max quantizer. Since the quantizer outputs fixed 32 bit codes, its alphabet could potentially be as large as 2³² letters. However, the compression level parameter C sets a constraint, which may be very weak (i.e. allow a large alphabet) at low compression ratios. The choice of a accomplishes the distortion optimization, for the alphabet size allowed by the user's choice of C. Together the choice of the α₁ and C determine Q.

In a preferred embodiment, the number of zero coefficients generated in each band is stored, allowing the RLE to dynamically assign bands to the symbol tables it produces. Let Pₖ denote the probability of the letter rₖ being in the output of the quantizer. More succinctly, let

$${P}_{k} = {\int }_{{d}_{k - 1}}^{{a}_{k}} f ( x ) ⅆ x ,$$

where f is the original signal. Then the minimum number of bits needed, on average to represent rₖ without loss is given by the entropy

$$H = - {\sum }_{k} {P}_{k} {log}_{2} {P}_{k} .$$

If the probability distribution of each letter produced by the quantizer were uniform, then the minimum number of bits needed to represent each letter would be simply be

$$- K \frac{1}{κ} {log}_{2} \frac{1}{κ} .$$

Most signals however have a more or less Gaussian distribution, which the entropy coder, also known as a variable-length code, described later, takes advantage of.

After quantization, most of the wavelet coefficients are zeroes. This output is the significant or significance map of the transform. Run Length encoding, commonly known as RLE, takes advantage of the significant's sparsity and is the next step in ThinWave compression. In its basic form, RLE looks for sequences of consecutive, identical coefficients. A sequence of coefficients is stored as a run length followed by an index where the index is the coefficient and the run length is ow long the sequence of identical coefficients is. ThinWave's RLE only looks for consecutive runs of zeroes, thus only the run length is stored and the index is implicitly zero. It also plays the dual role of mapping the quantized wavelet coefficients to the entropy coder's symbol table (alphabet).

ThinWave's RLE recursively and independently codes within each subband, in a way that takes advantage of which function produced the subband being coded. Each of the three wavelet filters outputs significant (i.e.>>0) wavelet coefficients that correspond to details with different spatial orientations. In particular, the significant coefficients from the outputs from the Ψφ and φΨ filters will correspond respectively, to vertically and horizontally oriented detail. Thus the output from the Ψφ filter is likely to contain long runs when scanned horizontally. Taking advantage of this, ThinWave's RLE scans these two outputs accordingly, resulting in significantly higher compression rates for most images.

ThinWave's Huffman coders allow an alphabet of up to 256 symbols. The RLE as well as performing run length coding of zeroes, also maps the non-zero wavelet coefficients to this alphabet via a symbol table. ThinWave's RLE stores run-lengths and wavelet coefficients in both fixed and variable length word sizes. The first fifty run lengths (1≦ run length ≦50) are stored as variable length codes via Huffman compression. Run lengths larger than 50 but less than 256 are stored as 8-bit words and runs longer than 256 are stored with words whose bit length is determined by log₂ of the longest run length encountered. Thus, short, frequently encountered run lengths are mapped by Huffman coding to the smallest possible code words, while the longer and less frequent runs that would likely be mapped by Huffman to lengthy bit sequences, are assigned bit sequences in a more fixed way. The wavelet coefficients are treated similarly, as indicated by the symbol table below and diagrams below.

Symbol Table Generated by RLE and the Escape Codes

| Symbol | Use |
|---|---|
| 0 | //End of file marker for Huffman |
| 1 | //Run length = 1 |
| 50 | //Run length = 50 |
| 51 | //Escape for 50 <run length ≦255 |
| 52 | //Escape for run length > 255 |
| 53 | //Escape for wavelet coefficient with 100 <magnitude |
| | ≦255 |
| 54 | //Escape for wavelet coefficient with magnitude >255 |
| 55 | //Wavelet coefficient = −100 |
| 56 | //Wavelet coefficient = −99 |
| 154 | //Wavelet coefficient = −1 |
| 155 | //End of RLE segment marker |
| 156 | //Wavelet coefficient = 1 |
| 254 | //wavelet coefficient = 99 |
| 255 | //wavelet coefficient = 100 |

Entropy Coded RL and Coefficients

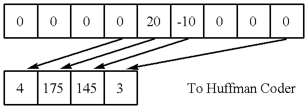

8-bit RL, Coefficients and Escapes

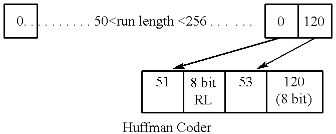

RL, Coefficients > 255 and Escapes

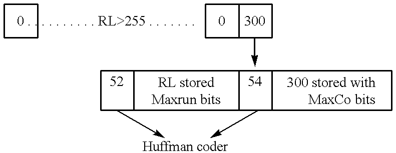

MaxRun = log₂ (largest run length)
MaxCo = log₂ (largest coefficient)

Because the significant of the wavelet transform is likely to contain a much higher proportion of zeroes in the highest resolution subbands, the signal being sent to the RLE and entropy coders is non-stationary, as the subband quadtree is vertically traversed. Thus ThinWave vertically divides the quadtree structure into three, statistically similar regions, resulting in three output streams, fed to three Huffman coders. A preferred embodiment divides the tree dynamically, according to the density of zero coefficients produced in each band by the quantization step.

The last step in ThinWave compression is entropic coding, utilizing Huffman compression. Entropy coding generates a codebook of variable length codewords (i.e. bit sequences) mapped to the letters in the coder's alphabet according to the probability of the letters'occurrence. Letters with a high probability of occurrence are assigned short codewords, while rarely encountered letters are assigned longer words. This allows the data to be stored in a form whose entropy is very close to that of the data, resulting in compression of most data sets, as compared to fixed length storage.

As previously mentioned, the codeword for each letter is generated according to the probability of occurrence of that letter. A Probability Distribution Function (or PDF), Pₖ, describes the probability of the occurrence of the letter rₖ. P can either be built from each instance of data, or it can be estimated before hand, perhaps as the aggregate of PDFs from many data sets. The advantage of using a fixed, pre-estimate PDF is that a fixed codebook is implied, eliminating the need to build a new codebook for each data set and, perhaps more importantly, eliminating the need to transmit this codebook to the receiver. The disadvantage is that a fixed, estimated PDF will usually, not be well-matched to the PDF of the particular instance of a data set. Thus the coder's output will not be as close to the entropy of the data set as it would be if it used a PDF built from the data instance. This results in lower compression rates, offsetting the gains made from not having to explicitly transmit the codebook. This is particularly true of larger data sets where the codebook size is trivial compared to that of the data set.

ThinWave builds new PDF's for each image. For the reasons mentioned in the section on RLE, ThinWave uses three coders-i.e. codebooks for the image. Thus, three PDF's are built and codebooks are built from each.

In the present invention, the Huffman trees and resulting codebooks are built recursively with a priority queue, implemented with a binary heap. Using a heap is decidedly advantageous over other priority queue methods such as linked lists. On average, a binary heap can build and delete minimum values in 0(n) time. Thus if the alphabet being built has N letters, there will be one BuildHeap, (2N−2) DeleteMinimums and (N-2) Inserts on a heap that never has more than N elements. This yields a Huffman tree build time of O(NlogN), as compared to O(N²) using other priority queue methods.[Weiss]

ThinWave uses a novel method to reduce the usual overhead incurred by Huffman codebook transmission by 60% or more. This allows effective use of multiple codebooks, even with small data sets, for reasons described in the section RLE coding.

It is well known that a codebook build by Huffman coding for a given data set is not unique. That is, for a given data set and its associated PDF, there are many codebooks that can be built that perform identically as far as entropy minimization. When a Huffman tree is built, the letters, rₖ, are initially thought of as a forest of trivial (single node) trees, each of which is initially assigned a probability of occurrence by Pₖ. The two trees with the smallest probabilities are merged into a new tree whose probability (or weight) is the sum of the probabilities of its two children. This process is repeated until the entire forest has been merged into one tree. This is a greedy algorithm in that the ordering of the merges is strictly dependent upon what the next two trees with the smallest weights are. Because each tree's weight is simply the sum of its node's weights, there is no guarantee that within any given level of the tree, going left to right for example, one will find any particular ordering of the letters represented by the codewords at that level.

ThinWave produces a particular of canonical, Huffman tree for a given PDF, structured so that within each level, from left to right, the codewords in that level (i.e. codewords whose length equals the depth of that level) are strictly ascending in their mapping to the coder';s alphabet. This makes it possible for the receiver to use this convention to build an identical codebook, based only on an ordered sequence of lengths, rather than the exact codebook itself. As with naive transmission of the codewords, the mapping to the decoders alphabet is implicit. This ordered sequence of lengths is bit packed with each word being log₂ (number of bits in longest sequence). Because only the lengths rather than the actual bit-sequences are being transmitted, this results in most codebooks being transmitted by 4 bits or less per codeword.

1. A method for lossy compression of digitized images, comprising the steps of,
(a) wavelet transformation of the image, with smoothing and extending to reduce high frequency contents, said step including steps of
(i) determining a linear interpolation consisting of a line, joining the first and last pixels in each row and in each column of the image,
(ii) determining how many factors of two are present in each dimension of the image,
(iii) extending these dimensions until each has at has at least four factors of two present,
(iv) allocating the memory needed to extend the image to the new dimensions, resulting in a memory buffer containing the image data augmented by a padding of uninitialized memory cells to the right and bottom of cells containing the image data,
(v) joining the first and last pixels of each row and column by writing the linear interpolation function generated into the image extension padding supplied by step (iv), and
(vi) performing a discrete wavelet transform on the extended image generated by steps (i) through (v), producing a quad-tree data structure which contains the wavelet transform of the image;
(b) quantization by conversion of the floating point coefficients, output by step (a)(i), into a fixed alphabet (Spec 3.2) of L-bit integers with a separate and fixed, quantization function for each band of coefficients within the wavelet transform output by (a) (vi), wherein the separate quantization functions have been determined to be nearly optimal in rate vs. distortion for subsequent compression of most
(c) Run length encoding (RLE) by the following steps,
(i) Three run Length Encoders are assigned to vertically traverse the tree, with each being assigned to certain, vertically contiguous bands of the tree, according to step (c)(i),
(ii) The subbands contained in each band are horizontally or vertically scanned according to the type of wavelet filter (Spec3.11) producing each said subband, and
(iii) Mapping by RLE of quantized coefficients by a symbol table (Spec 3.31) to three sets of new coefficients, each drawn from statistically similar regions of the quad-tree, representing the data dn zero run lengths, whereby resulting output effects improved subsequent entropy compression;
(d) Huffman entropy coding of the image data output by step
(c) into three sets of coded data by
(i) Building a separate probability density function (PDF) for each of the three data sets,
(ii) Constructing a separate Huffman codebook for PDF
(iii) Mapping the data to variable length code words using the codebooks built in step b. resulting in improved compression due to the similar distributions of the data sets within each of the three data sets; and
(e) Mapping and compaction of the codebooks generated by
(d)(iii) to new codebooks wherein,
(i) The codebooks generated by (d) (iii) are mapped into new codebooks which can be implicitly stored by a sequence of codeword lengths (Spec 3.43), and
(ii) These lengths are stored with words whose bit length=log₂ (Largest word length) resulting in substantial savings of storage space when compared to explicit storage of the original codebooks, thus further enhancing the benefits gained by using multiple codebooks.

2. A method for performing image compression as stated in claim 1, wherein linear interpolation is used in step to minimize high frequency artifacts at image boundaries.

3. A method of quantization as stated in claim 1, further comprising a fixed profile of the wavelet bands in conjunction with alphabet constraint to achieve a nearly optimal rate/distortion with minimal computation effort.

4. A method of RLE coding as stated in claim 1, further comprising RLE within each band, to better take advantage of each band's significance.

5. A method of RLE coding as stated in claim 4, further comprising the, per image, development of several independent RLE coders to take advantage of the statistics within the wavelet coefficient bands.

6. A method of entropy coding, as stated in claim 1, further comprising the per-image development of several Huffman generated codebooks which are used to advantageously exploit the statistical characteristics of the wavelet bands.

7. A method of entropy coding, as stated in claim 6, further comprising the use of mapping Huffman codes to significantly reduce codebook size.
